(19) United States
(12) Patent Application Publication
(10) Pub. No.: US 2014/0193584 A1
(43) Pub. Date: Jul. 10, 2014

(54) Method Of Improving Performance Of Footwear Having Cleats As Well As Helmets In Contact Sports

(71) Applicant: Robert Dean Van Essen, Hudsonville, MI (US)

(72) Inventor: Robert Dean Van Essen, Hudsonville, MI (US)

(73) Assignee: ROBERT D. VAN ESSEN DDS, PC, Hudsonville, MI (US)

(21) Appl. No.: 14/147,980

(22) Filed: Jan. 6, 2014

Related U.S. Application Data
(60) Provisional application No. 61/749,533, filed on Jan. 7, 2013.

(51) Int. Cl. B05D 5/00

(52) U.S. Cl. CPC B05D 5/00
USPC 427/355; 427/402; 427/421.1

(57) ABSTRACT

A method of improving performance of equipment for a contact sport having the steps of: providing a shoe having an outsole and at least one cleat; providing a lubricant in a container; applying the lubricant to portions of the outsole and the at least one cleat; providing a helmet used in a contact sport; providing at least one of a second lubricant and a wax; and applying at least one of the second lubricant and a wax to the helmet to reduce the friction on the surface thereof.

### CROSS-REFERENCE TO RELATED APPLICATION

This application claims priority from U.S. Provisional Patent Application Ser. No. 61/749,533 filed Jan. 7, 2013, entitled “Method Of Improving Performance Of Footwear Having Cleats,” the entire disclosure of which is hereby incorporated by reference in its entirety.

### BACKGROUND OF THE DISCLOSURE

1. Field of the Disclosure

The disclosure relates in general to improving performance in with athletic equipment, and more particularly, to a method of improving performance of footwear having cleats as well as helmets in contact sports.

2. Background Art

The use of athletic footwear having cleats is well known in the art. For example, football players have footwear with cleats to provide the necessary bite and traction on the field. Generally, such footwear includes a plurality of cleats that are molded (or screwed) into the outsole. The outsole is generally a molded polymer member, and the cleats are generally also molded polymer members. In the case of screwed in cleats, the cleats are a polymer member that is molded over a metal post-like member.

As the user runs on turf, the cleat digs into the turf to provide the necessary traction. In most instances, the remainder of the outsole also contacts the ground. Where the user is playing on natural turf, grass, dirt and other debris may become lodged onto the cleats. A certain amount of friction is encountered by the contact of the cleat with the turf as well as the outsole with the turf. In many instances, this friction is counterproductive, and robs the user of performance. In addition, this added friction may contribute to injury.

Additionally, there has been much in the way of research and injury related to head trauma caused by helmet to helmet collisions, as well as other impact type events. Problematically, current helmets tend to have surfaces that extend the impact of collisions (the violentness of which can be seen through the paint transfer from helmet to helmet). Furthermore, the transfer of momentum and energy from the colliding bodies is extended through extended contact.

It is an object of the present disclosure to lessen the friction between the outsole of a shoe and a cleat with the turf.

It is another object of the present disclosure to lessen the severity of an impact between a helmet and another body, such as another helmet.

It is another object of the present disclosure to provide helmets that reduce injury.

It is another object of the present disclosure to provide an improved shoe and cleat that lessens injury.

These objects as well as other objects of the present invention will become apparent in light of the present specification, claims, and drawings.

### SUMMARY OF THE DISCLOSURE

The disclosure is directed to a method of improving performance of equipment for a contact sport comprising the steps of: providing a shoe having an outsole and at least one cleat; providing a lubricant in a container; applying the lubricant to portions of the outsole and the at least one cleat; providing a helmet used in a contact sport; providing at least one of a second lubricant and a wax; and applying at least one of the second lubricant and a wax to the helmet to reduce the friction on the surface thereof.

In a preferred embodiment, the step of providing further comprises the step providing of a pair of shoes each having an outsole and each having a plurality of cleats.

In some such preferred embodiments, the plurality of cleats comprise the group consisting of: permanently attached cleats and detachable cleats.

In another preferred embodiment, the step of providing a lubricant comprises the step of providing a liquid lubricant in a container wherein the contents are under pressure, the container having a spray valve. Additionally, in such an embodiment, the step of applying the lubricant comprises the step of triggering the spray valve to apply the liquid lubricant from the container.

In another preferred embodiment, the step of providing a second lubricant and a wax comprises the step of providing a wax in a paste form. The step of applying further comprises the steps of applying the wax in paste form to the helmet and buffing the wax applied to the helmet.

In another preferred embodiment, the method further comprises the step of reapplying the lubricant to portions of the outsole and the at least one cleat.

In some such preferred embodiments, the method further comprises the steps of reapplying at least one of the second lubricant and the wax to the helmet to reduce the friction on the surface thereof.

In another aspect of the disclosure, the disclosure is directed to a method of improving performance of equipment for a sport comprising the steps of: providing a shoe having an outsole and at least one cleat; providing a lubricant in a container; and applying the lubricant to portions of the outsole and the at least one cleat.

In a preferred embodiment, the step of providing further comprises the step of providing of a pair of shoes each having an outsole and each having a plurality of cleats.

In certain such embodiments, the plurality of cleats comprise the group consisting of: permanently attached cleats and detachable cleats.

In other such preferred embodiments, the step of providing a lubricant comprises the step of providing a liquid lubricant in a container wherein the contents are under pressure, the container having a spray valve. The step of applying the lubricant comprises the step of triggering the spray valve to apply the liquid lubricant from the container.

In another preferred embodiment, it will be understood that the method further comprises the step of reapplying the lubricant to portions of the outsole and the at least one cleat.

In another aspect of the present disclosure, the disclosure is directed to a method of improving performance of equipment for a contact sport comprising the steps of: providing a helmet used in a contact sport; providing at least one of a second lubricant and a wax; and applying at least one of the second lubricant and a wax to the helmet to reduce the friction on the surface thereof.

In a preferred embodiment, the step of providing a second lubricant and a wax comprises the step of providing a wax in a paste form. Additionally, the step of applying further comprises the steps of applying the wax in paste form to the helmet and then buffing the wax applied to the helmet.

In another preferred embodiment, the method further comprises the steps of reapplying at least one of the second lubricant and the wax to the helmet to reduce the friction on the surface thereof.

### BRIEF DESCRIPTION OF THE DRAWINGS

The disclosure will now be described with reference to the drawings wherein:

FIG. 1 of the drawings is a sample shoe having a outsole with a cleat positioned thereon;

FIG. 2 of the drawings is a schematic representation of an applicator of lubricant to an outsole of a shoe to reduce friction;

FIG. 3 of the drawings is a sample helmet having an outer surface treated with the method of the present disclosure; and

FIG. 4 of the drawings is a canister containing an applicating formulation intended for use on a helmet or the like.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

Referring now to the drawings and in particular to FIG. 1, an article of footwear is shown generally at 10. The footwear (in this case, an athletic shoe) includes an upper 12, outsole 14, having a bottom surface 16 and cleats, such as cleat 18. The shoes shown are merely generic representations of a pair of athletic shoes having cleats positioned thereon.

Typically, the outsole 14 includes a molded polymer component and, in the embodiment shown, the cleats are molded into the outsole. The cleats are spaced apart from each other and in strategic locations so that proper traction on turf is provided by the cleats. It has been found, however, that while the cleats provide the necessary traction to the shoe and to the user, the surface friction of the outsole and the cleat provides undesirable negative traction. For example, the surface friction can often negatively impact the speed and movement of the player. In addition, the surface friction can preclude the separation of the shoe from the turf, when, for example, the user is hit or impacted.

To overcome these negative impacts of the surface friction of the outsole and the cleats, it has been found that lowering the friction of the outsole and the cleats with a liquid lubricant (such as lubricant 20 on the sole) greatly lowers the friction of the surfaces. In one embodiment, the liquid lubricant is applied directly to the outsole and to the cleats.

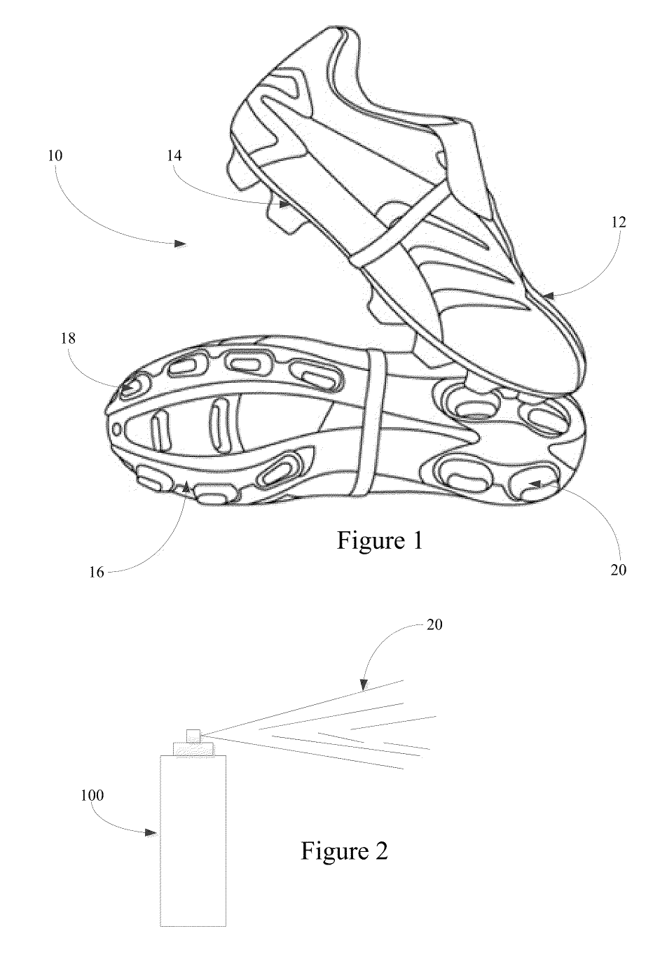

The same can be achieved through a number of different manners. For example, a liquid lubricant (such as an oil, such as a vegetable oil) can be applied with a brush to the outsole and to the cleats. In other embodiments, the lubricant can be formulated into a paste which can be rubbed onto the sole. In still other embodiments, the liquid lubricant can be in a pressurized container (with a propellant), or in a non-pressurized container, such as a spray pump. It will be understood that continued use of the shoes will tend to wear off the applied lubricant. Thus, reapplication becomes necessary at generally regular intervals. In the preferred embodiment, and with reference to FIG. 2, lubricant 20 is supplied in a pressurized container 100.

Any number of different lubricants are contemplated for use, and it will be understood that the particular choice of lubricant can be varied based upon a number of different factors, including but not limited to, turf surface material, turf surface condition, player weight, construction of the shoes, construction of the cleats, shape of the outsole and cleats, weather conditions, among other considerations.

In operation, the user first selects the particular shoe that he or she will be using. The user then applies the lubricant to the outsole and to the cleats. In the preferred embodiment, the lubricant is provided in liquid form in a pressurized container with a propellant. The user can direct the spray nozzle of such a container to apply a generally uniform layer on the outsole and the cleat. Generally, the liquid lubricant is applied to the surfaces that are likely to come into contact with the turf.

As the user continues to play on the field, the liquid lubricant is generally worn off the outsole and the cleats. Thus, the user can reapply the liquid lubricant as often as necessary so that an adequate amount of liquid lubricant is on the portions of the outsole and the cleats that make contact with the ground.

In another aspect of the disclosure, it is also contemplated that the same liquid lubricant can be applied to sporting helmets so as to allow other helmets, pads, and structures to bounce off the helmet more expeditiously.

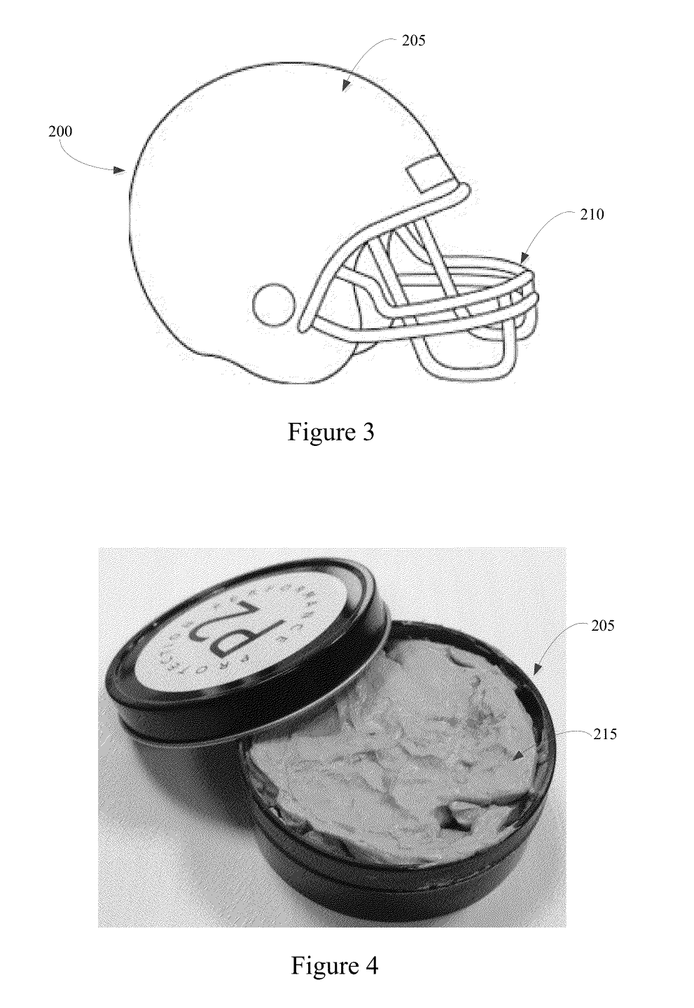

One such formulation is shown in FIGS. 3 and 4, and may comprise any of the lubricants disclosed above, and may also include waxes and the like. As explained above, the goal is to reduce the friction so that the helmet can limit the impact and the time of an impact when hitting another body. The helmet may include an outer hard surface 200 as well as a face guard 210.

In one embodiment, a paste wax (or a liquid, or solid wax) 205 within container 215 can be utilized. One example of a paste wax is available from S.C. Johnson and Son of Racine, Wis. The wax can be applied in a single layer or in multiple layers to the helmet surfaces, then buffed, which may include both the outer hard surface 200 as well as the face guard 210. The helmet is then utilized in the common manner playing the contact sport. It has been found that as the surfaces become more highly polished, the duration of an impact can be reduced, as well as, in turn, the severity of the impact. It will be understood that that the lubricant/polish can be reapplied as needed to the helmet as it will tend to wear away with use.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A method of improving performance of equipment for a contact sport comprising the steps of:
providing a shoe having an outsole and at least one cleat;
providing a lubricant in a container;
applying the lubricant to portions of the outsole and the at least one cleat;
providing a helmet used in a contact sport;
providing at least one of a second lubricant and a wax; and
applying at least one of the second lubricant and a wax to the helmet to reduce the friction on the surface thereof.

2. The method of claim 1 wherein the step of providing further comprises the step of providing of a pair of shoes each having an outsole and each having a plurality of cleats.

3. The method of claim 2 wherein the plurality of cleats comprise the group consisting of: permanently attached cleats and detachable cleats.

4. The method of claim 1 wherein the step of providing a lubricant comprises the step of:
providing a liquid lubricant in a container wherein the contents are under pressure, the container having a spray valve; and
the step of applying the lubricant comprises the step of:
triggering the spray valve to apply the liquid lubricant from the container.

5. The method of claim 4 wherein the step of providing a second lubricant and a wax comprises the step of providing a wax in a paste form and the step of applying further comprises the steps of:
applying the wax in paste form to the helmet; and
buffing the wax applied to the helmet.

6. The method of claim 1 further comprising the step of:
reapplying the lubricant to portions of the outsole and the at least one cleat.

7. The method of claim 6 further comprising the steps of:
reapplying at least one of the second lubricant and the wax to the helmet to reduce the friction on the surface thereof.

8. A method of improving performance of equipment for a sport comprising the steps of:
providing a shoe having an outsole and at least one cleat;
providing a lubricant in a container; and
applying the lubricant to portions of the outsole and the at least one cleat.

9. The method of claim 8 wherein the step of providing further comprises the step of providing of a pair of shoes each having an outsole and each having a plurality of cleats.

10. The method of claim 9 wherein the plurality of cleats comprise the group consisting of: permanently attached cleats and detachable cleats.

11. The method of claim 8 wherein the step of providing a lubricant comprises the step of:
providing a liquid lubricant in a container wherein the contents are under pressure, the container having a spray valve; and
the step of applying the lubricant comprises the step of:
triggering the spray valve to apply the liquid lubricant from the container.

12. The method of claim 1 further comprising the step of:
reapplying the lubricant to portions of the outsole and the at least one cleat.

13. A method of improving performance of equipment for a contact sport comprising the steps of:
providing a helmet used in a contact sport;
providing at least one of a second lubricant and a wax; and
applying at least one of the second lubricant and a wax to the helmet to reduce the friction on the surface thereof.

14. The method of claim 13 wherein the step of providing a second lubricant and a wax comprises the step of providing a wax in a paste form and the step of applying further comprises the steps of:
applying the wax in paste form to the helmet; and
buffing the wax applied to the helmet.

15. The method of claim 13 further comprising the steps of:
reapplying at least one of the second lubricant and the wax to the helmet to reduce the friction on the surface thereof.
